(19) United States
(12) Patent Application Publication
(10) Pub. No.: US 2006/0194014 A1
(43) Pub. Date: Aug. 31, 2006

(54) Mock patterns for interior decorating

(76) Inventors: David C. Ryan, Sandown, NH (US); Pamela C. Peters, South Portland, ME (US)

Correspondence Address: Kevin M. Farrell;Pierce Atwood, Suite 350, One New Hampshire Avenue, Portsmouth, NH, 03801, US

(21) Appl. No.: 11/059,932

(22) Filed: Feb. 17, 2005

(51) Int. Cl. B32B 33/00

(52) U.S. Cl. 428/40.1; 428/43; 428/195.1

(57) ABSTRACT

A mock surface for interior decorating is presented herein. The mock surface includes a flexible material that can be easily and efficiently disposed over any area or structure to be finished. The flexible material includes a first surface and a second surface, each of which may have a unique pattern disposed thereon. In one embodiment, the flexible material is disposed about a spindle for easy storage, distribution and removal. In another embodiment, the second surface is selectively covered in an adhesive material for securing the mock pattern to a surface to be finished, such as a countertop. Frangible lines incorporated in to the flexible material permit a user to selectively segment portions of the flexible material for use. The flexible material of the present invention is sized over a large range covering between sixteen and seventy-two square feet of surface area.

### BACKGROUND AND SUMMARY OF THE INVENTION

It is known in the art for homeowners, renters and real estate investors to seek to improve the features of a dwelling, including the addition or replacement of surfaces such as the floors, walls and countertops. The addition of an entire surface to a kitchen floor, for example, can be a costly and time-consuming enterprise. Aside from the mechanics of cutting and placing the tile or covering material, there are aesthetic concerns that also should be addressed, such as how the tile or covering material will appear to a viewer.

The current state of the art for addressing these aesthetic concerns is the user of a sample surface, such as a single tile or tab simulating a countertop surface, shown in FIG. 1. For illustrative purposes, a single tile 1 may measure eight inches square, for an area of sixty-four square inches. A sample tab 3 may measure two inches by three inches, covering an area of six square inches, or approximately the size of a business card. Nevertheless, consumers continue to use the prior art because the tile 1 will have a desired tile surface 2, and the sample tab 3 will have a desired countertop surface 4.

In spite of the continuing demand for the prior art products, they present a number of problems and pitfalls for the consumer. Notably, it is difficult to judge the aesthetic qualities of an entire floor space covered in tile by using the single tile 1. Likewise, a consumer looking to resurface her countertops will find it difficult to appreciate the final product by using the sample tab 3.

There is a need in the art for a reliable device for determining the aesthetic qualities of a surface to be installed. Moreover, such a solution should be easily reproduced and inexpensive to manufacture and purchase. Lastly, the solution should be readily adapted for simulating a number of surfaces, including tiles, paneling, ceramics, granite, and other popular synthetic countertops.

Accordingly, the present invention includes a mock surface for interior decorating including a flexible material that can be easily and efficiently disposed over any area or structure to be finished. The flexible material includes a first surface and a second surface, each of which may have a unique pattern disposed thereon. In one embodiment, the flexible material is disposed about a spindle for easy storage, distribution and removal. In another embodiment, the second surface is selectively covered in an adhesive material for securing the mock pattern to a surface to be finished, such as a countertop. The flexible material of the present invention is sized over a large range covering between sixteen and seventy-two square feet of surface area.

The foregoing background and summary is intended to introduce the reader to the present invention. More particular features and advantages of the present invention are described below with reference to the following figures.

### BRIEF DESCRIPTION OF THE DRAWINGS

FIG. 1 is a perspective view of the prior art.

FIG. 2 is a perspective view of the present invention.

FIG. 3 is a top plan view of the present invention.

FIG. 4 is a bottom plan view of the present invention.

FIG. 5 is a detailed bottom plan view of the present invention.

FIG. 6 is a perspective view of a typical kitchen showing a plurality of surfaces and the present invention in use.

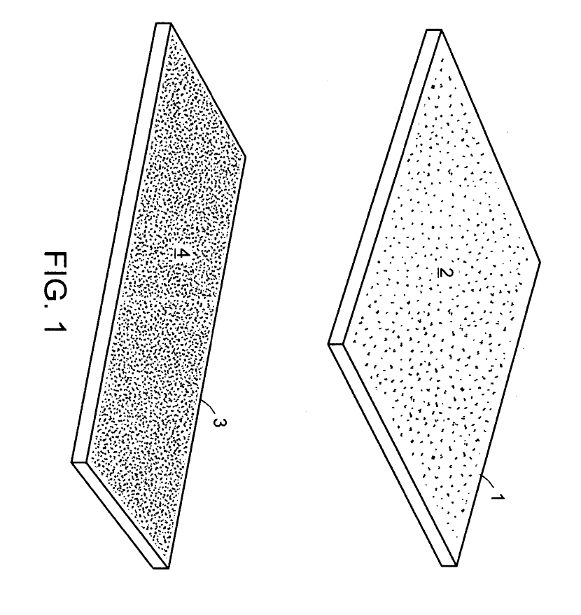

### DETAILED DESCRIPTION OF THE PREFERRED EMBODIMENTS

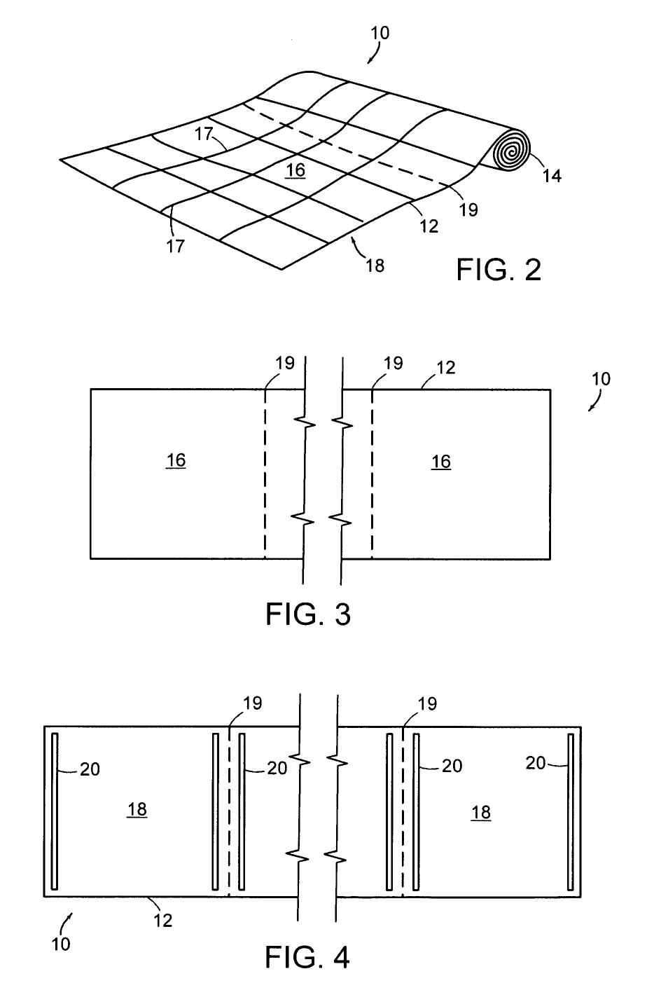

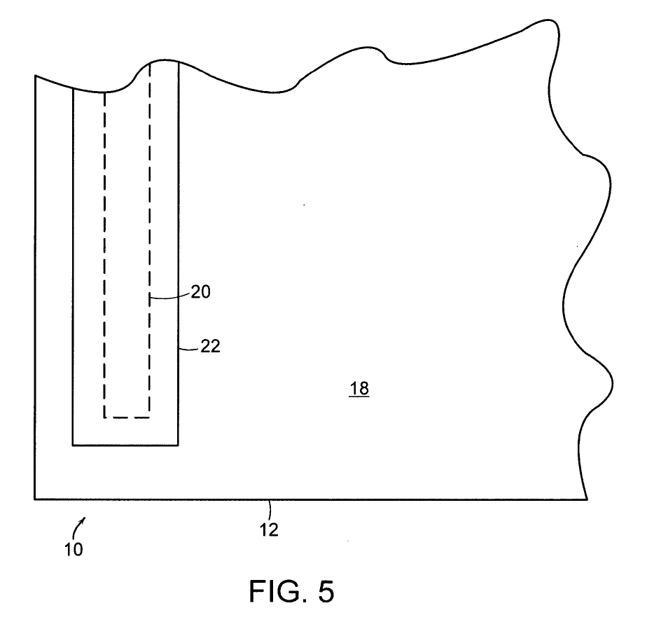

Referring now to FIGS. 2-5, the present invention will be described in detail. As previously noted, the present invention includes a mock surface. The mock surface includes a flexible material having first and second surfaces, at least one of which has a pattern that mocks or emulates a real surface that the consumer is considering using to finish a floor, wall or countertop. As the mock surface includes a flexible material, it may be easily used and stored. Additionally, given that the flexible material can be conveniently folded or rolled, for example on a spindle, the present invention can be formed in large sizes that are suitable for covering an entire area of interest.

In particular, a preferred mock surface is between two and four feet in width and between four and twenty feet in length. Consequently, the preferred mock surface will cover between eight and eighty square feet of surface area. Most preferably, the mock surface is approximately three feet in width and twelve to sixteen feet in length, covering approximately thirty-six to forty-eight square feet of surface area. It should be understood that the mock surface of the present invention could be constructed in any dimension as required by consumer demand or particular applications. Any aberrations from the ranges described above should be understood to be mere design choices.

Referring now to FIG. 2, the mock surface 10 is shown in perspective view in one preferred embodiment. As shown, the mock surface 10 includes a flexible material 12, such as paper, vinyl, acrylic, Mylar®, fabric or any other synthetic or natural composite that possesses the necessary flexibility for easy use and storage. In a preferred embodiment, the flexible material 12 is a paper product, thus allowing for mass production at little expense to the manufacturer.

The flexible material 12 defines a first surface 16 and a second surface 18 (not shown). The flexible material 12 is shown partially rolled on a spindle 14. For purposes of the present invention, the spindle 14 may be composed of wood, cardboard or any synthetic material or plastic that can be formed into an elongated structure with the necessary rigidity to easily roll and store the flexible material.

As the flexible material 12 may be rolled onto and stored on the spindle 14, the flexible material 12 can have large dimensions. For example, in a flooring application, the flexible material 12 may be twelve to sixteen feet in length in order to cover an entire hallway. Alternatively, the flexible material 12 may be divided by a consumer using scissors or some other cutting mechanism. In another embodiment, the flexible material 12 may incorporate at least one frangible line 19 at selected points for easy division of the flexible material 12 into readily usable portions.

As shown in FIG. 2, the first surface 16 may have a first pattern 17 disposed thereon (shown as a grid in FIG. 2). For example, the first pattern 17 may be that of a series of tile. Alternatively, the first pattern 17 may be a simulated hardwood floor, a ceramic or granite countertop, or any other surface or finish that a consumer may wish to use for home décor. The exact pattern that is disposed on the first surface 16 is limited only by the imagination of interior designers, and as trends in home décor evolve, it should be understood that the first pattern 17 would evolve in tandem. Thus, as time passes and there are changes in consumer demand, regional preferences and decorating styles of the times, the first pattern 17 can be expected to change as well.

FIG. 3 is a top plan view of an alternate embodiment of the present invention in which the flexible material 12 is not rolled or stored on a spindle, as shown in FIG. 2. In certain applications, such as countertop décor, it may be more appropriate to form the flexible material 12 into segments that are smaller than those contemplated for a flooring application. As previously noted, however, the flexible material 12 is divisible by scissors or some other cutting mechanism. Still more preferably, the flexible material 12 incorporates frangible lines 19 that permit a user to break the flexible material 12 into smaller portions for use in certain applications, such as kitchen countertops and the like.

FIG. 4 is a bottom plan view of the alternate embodiment of the present invention. As shown here, the bottom surface 18 may have a series of adhesives 20 applied thereto at selected intervals. The adhesives 20 are particularly beneficial for arranging the flexible material 12 along a wall, for example, to model a wood finish for cabinetry. The adhesives 20 are also disposed about the frangible lines 19 such that the flexible material 12 can be broken into segments by a user and secured into various arrangements, for example, while modeling a floor space with a proposed wood/tile combination finish.

Turning now to FIG. 4, a detailed view of the bottom surface 18 of the present invention is shown. In a preferred embodiment, the adhesive 20 (shown in phantom) is covered by a protective tape 22 when the mock surface 10 is not in use. When the consumer wishes to use the mock surface 10, she has the option to remove the protective tape 22 and expose the adhesive 20 for affixing the mock surface 10 to a particular space or area. It should be noted that the protective tape 22 prevents the adhesive from sticking to any other portion of the flexible material 12, and thus the flexible material 12 may be rolled onto a spindle 14 while maintaining the integrity of the adhesive.

In order to reduce the overall costs to consumers, the flexible material 12 may have both first and second patterns disposed on the first surface 16 and the second surface 18, respectively. Thus, with one purchase, a user can compare two different types of surfacing options simply by turning over the flexible material 12. As there are applications in which the user may wish to secure the flexible material via the adhesive 20, the protective tapes 22 will incorporate the respective patterns so as to become sufficiently invisible to the user so as not to be a distraction. Accordingly, in a another preferred embodiment, the present invention can be maximized by utilizing both the first surface 16 and the second surface 18, each with a distinct pattern and each with a series of adhesives 20 covered by protective tapes 22. Additionally, a plurality of frangible lines can be incorporated into the flexible material 12 to permit a user to select portions of the flexible material 12 for use in particular applications.

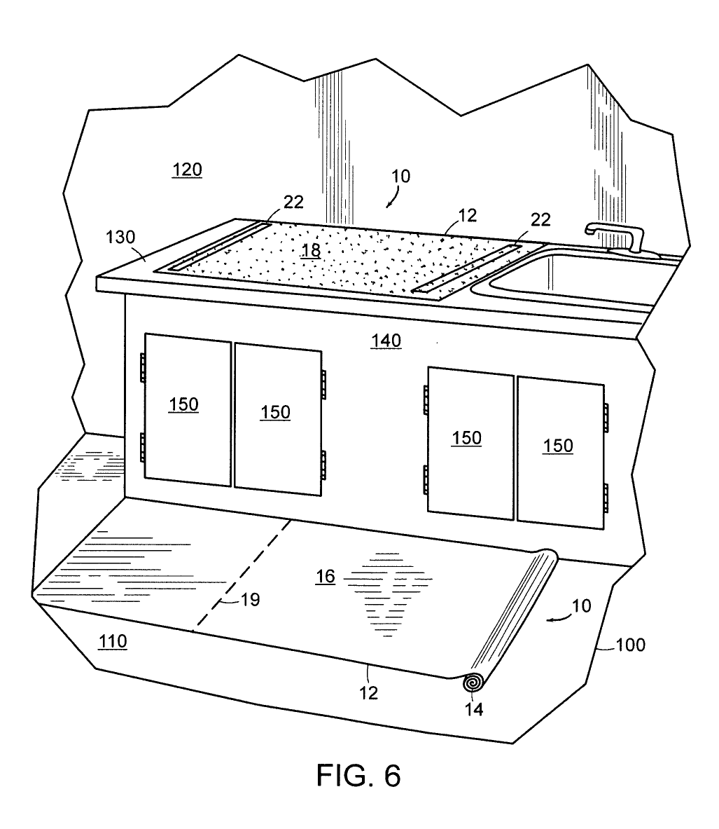

FIG. 6 is a perspective view of a typical kitchen 100 in which the present invention may be used. As seen, the kitchen 100 defines a number of surfaces and areas, including a floor 110, a wall 120, a countertop 130, cabinetry 140 and cabinet doors 150. As shown, the mock surface 10 is in use in multiple areas. Covering the floor 110 is a portion of the mock surface 10 that is partially stored on the spindle 14 and exposing the first surface 16. The flexible material 12 incorporates at least one frangible line 19. A second frangible line (not shown) has been broken such that the second portion of the mock surface 10 can be used to cover a portion of the countertop 130. As shown, the second portion of the mock surface 10 is displaying the second surface 18, which incorporates a pattern distinct from that of the first surface 16. Protective tapes 22 are shown incorporating the same pattern as found on the second surface 18 so as not to distract the user.

As described here, the present invention allows a user a great deal of latitude with respect to envisioning a future space or surface. The present invention includes a flexible material that can be selectively segmented and affixed to both structures and surfaces, such as countertops, walls, ceilings and floors. Although numerous features and advantages of the present invention have been described in the foregoing, the exact nature and scope of the invention is distinctly and particularly pointed out in the following claims.

We claim:

1. A mock surface for interior decorating comprising:
a flexible material defining a first surface and a second surface, the first surface opposite the second surface; and
a first pattern comprising a pattern of interest, the first pattern disposed on the first surface, the pattern of interest imitating an actual surface that is intended for interior decorating.

2. The mock surface of claim 1 wherein the flexible material is storable about a spindle.

3. The mock surface of claim 1 further comprising an adhesive material disposed on the second surface.

4. The mock surface of claim 3 wherein the adhesive material is disposed at selected intervals on the second surface.

5. The mock surface of claim 3 further comprising protective tape disposed over the adhesive material.

6. The mock surface of claim 1 further comprising an adhesive material disposed on the first surface.

7. The mock surface of claim 6 wherein the adhesive material is disposed at selected intervals on the first surface.

8. The mock surface of claim 6 further comprising protective tape disposed over the adhesive material.

9. The mock surface of claim 1 further comprising a frangible line incorporated within the flexible material for selectively segmenting the flexible material.

10. The mock pattern of claim 1 further comprising a second pattern disposed on the second surface, the second pattern being distinct from the first pattern.

11. A method of decorating a surface comprising:
identifying a surface of interest to be decorated;
providing a mock surface comprising a flexible material defining a first surface and a second surface, the first surface opposite the second surface wherein a first pattern is disposed on the first surface,
placing the mock surface over the surface of interest to visualize an appearance of the surface of interest; and
selecting a genuine surface that is imitated by the mock surface in response to the appearance of the surface of interest.

12. The method of claim 10 wherein the mock surface is storable about a spindle.

13. The method of claim 10 further comprising the step of securing the mock surface to the surface of interest using an adhesive material disposed on the flexible material.

14. The method of claim 10 further comprising the step of providing a second pattern disposed on the second surface, the second pattern being distinct from the first pattern.

15. The method of claim 14 further comprising the step of selecting between the first and second patterns.
